(19) United States
(12) Patent Application Publication
(10) Pub. No.: US 2018/0300404 A1
(43) Pub. Date: Oct. 18, 2018

(54) LEERECS SYNESTHETIC LIBRARY

(71) Applicant: JOSE ANTONIO LEMOS-MUNOZ, BRONXVILLE, NY (US)

(72) Inventor: JOSE ANTONIO LEMOS-MUNOZ, BRONXVILLE, NY (US)

(21) Appl. No.: 15/488,515

(22) Filed: Apr. 17, 2017

(51) Int. Cl. G06F 17/30

(52) U.S. Cl. CPC G06F 17/30752; G06F 17/30761

(57) ABSTRACT

A COMPUTER PROGRAM TO BE OPERATED ON THE INTERNET BROWSER OF PERSONAL COMPUTERS AND OR THE NATIVE OPERATIVE SYSTEM OF DIGITAL PORTABLE DEVICES SUCH AS TABLETS OR SMART-PHONES WITH THE PURPOSE OF TRANSFERRING DATA, BOTH INPUT AND OUTPUT, FROM A DATABASE. SPECIFICALLY PROGRAMMED TO ORGANIZE ITEMIZED ARTICLES, BATCHES OF INFORMATION AND OR PRODUCTS IN AN INVENTORY ON A NEW AND INTUITIVE MANNER, TRANSPARENT TO PREDICAMENT, PREJUDGE OR EXCLUSIVE KNOWLEDGE.

### CROSS-REFERENCE TO RELATED APPLICATIONS

U.S. 62/449,701 PROVISIONAL PATENT

### STATEMENT REGARDING FEDERALLY SPONSORED RESEARCH OR DEVELOPMENT

NOT APPLICABLE

### COMPUTER PROGRAM LISTING

```
            $QUERY_COLOURS = “SELECT * FROM SMFWH_MESSAGE_ICONS WHERE
ID_BOARD = 5 ORDER BY ICON_ORDER ASC”; $RESULT =
MYSQL_QUERY($QUERY_COLOURS); IF (!$RESULT) { $MESSAGE = ‘INVALID
QUERY: ’ . MYSQL_ERROR( ) . “\N”; $MESSAGE .= ‘WHOLE QUERY: ’ .
$QUERY_COLOURS; DIE($MESSAGE);} ECHO ‘<DIV CLASS=“CAT_BAR”>
<H3>‘,$TXT[‘COLOURS’],’</H3></DIV><DIV><H3>GO AHEAD AND SELECT A
COLOUR TO BEGIN ! . . . </H3><FORM METHOD=“POST” ACTION=”?
ACTION=DO_SEARCH”>’;
            WHILE ($ROW = MYSQL_FETCH_ASSOC($RESULT)) {ECHO “<BUTTON
CLASS=‘SHADOW’ TITLE=’”.$ROW[‘VALUES’].“‘ TYPE=‘SUBMIT’ NAME=‘SEARCH’
VALUE=”.$ROW[‘TITLE’].“><IMG TYPE=‘SUBMIT’ CLASS=‘COLOUR’
SRC=‘/IMG/UNTITLED.PNG’ TITLE=‘“.$ROW[‘TITLE’].”’ STYLE=’BACKGROUND-
COLOR: #“.$ROW[‘FILENAME’].”;‘><P CLASS=‘COLOURP’>”.
$ROW[‘TITLE’].“</P></BUTTON>”;} ?>
            IF (ISSET($_POST[‘SEARCH’])) {$HEX =
MYSQL_REAL_ESCAPE_STRING($_POST[‘SEARCH’]); $HEX = HTMLENTITIES($HEX);
$QUERY_COLOURS = “SELECT SUM(SMFWH_LOG_POLLS.ID_CHOICE=1) AS
VALUE_SUM, SMFWH_MESSAGES.*, SMFWH_LOG_POLLS.* FROM \grave{ }SMFWH_MESSAGES\grave{ }
INNER JOIN \grave{ }SMFWH_LOG_POLLS\grave{ } ON
SMFWH_MESSAGES.ID_TOPIC=SMFWH_LOG_POLLS.ID_POLL WHERE
SMFWH_LOG_POLLS.ID_CHOICE IN (‘1’, ‘0’) AND SMFWH_MESSAGES.ICON LIKE
‘“ . $HEX . ”’ GROUP BY SMFWH_MESSAGES.BODY ORDER BY VALUE _SUM DESC”;
$RESULT = MYSQL_QUERY($QUERY_COLOURS); IF (!$RESULT) { $MESSAGE =
‘INVALID QUERY: ’ . MYSQL_ERROR( ) . “\N”; $MESSAGE .= ‘WHOLE QUERY:
‘. $QUERY_COLOURS; DIE($MESSAGE); } WHILE ($ROW =
MYSQL_FETCH_ASSOC($RESULT)) { $HEXCODE = $ROW[‘HEXCODE’];
$SUM = $ROW[‘VALUE_SUM]; $QUERY_MEMBERS = “SELECT * FROM
\grave{ }SMFWH_MESSAGES\grave{ } WHERE ”.$ROW[‘ID_TOPIC’].“= ID_MSG ”;
$MEM = MYSQL_QUERY($QUERY_MEMBERS); IF (!$MEM) { $MESSAGE = ‘INVALID
QUERY: ’ . MYSQL_ERROR( ) . “\N”; $MESSAGE .= ‘WHOLE QUERY: ’ .
$QUERY_MEMBERS; DIE( MESSAGE);} $BERS = MYSQL_FETCH_ASSOC($MEM);
            $JOIN2 = “SELECT * FROM \grave{ }SMFWH_ATTACHMENTS\grave{ } WHERE ID_MSG =
“. $ROW[‘ID_MSG’].” LIMIT 1”;  // GET RESULTS
$RESULT2 = MYSQL_QUERY($JOIN2); IF (!$RESULT2) { $MESSAGE = ‘INVALID
QUERY: ’ . MYSQL_ERROR( ) . “\N”; $MESSAGE .= ‘WHOLE QUERY: ’. $JOIN2;
DIE($MESSAGE); } $ROW2 = MYSQL_FETCH_ASSOC($RESULT2); <DIV STYLE =“
BORDER: BACKGROUND-COLOR:‘,$ROW[‘ICON’],’;”>
```

### BACKGROUND OF THE INVENTION

AS A FINE ARTS GRADUATE, INTERACTIVE ART DIRECTION PROFESSIONAL AND A MUSICIAN FOR LIFE; I OBSERVED THE LACK OF NONVERBAL, SYMBOLIC ONLY, WHILE UNIVERSAL—BEYOND LINGUISTIC—APPROACH TO MUSICAL ITEMISATION OR CATEGORISATION. I WAS LOOKING FOR A NEW WAY TO FIND MUSIC WITHOUT THE PREDICAMENTS OR PREJUDGEMENT OF WORDS, GENRES, COMMENTARIES, AND EVERY OTHER ARTIFICIAL DEFINITION OF AN ELEMENT THAT IS MADE TO BE FELT RATHER THAN EXPLAINED.

### BRIEF SUMMARY OF THE INVENTION

“LEERECS SYNESTHETIC LIBRARY” IS A COMPUTER PROGRAMME TO CATALOGUE MUSIC BY COLOUR; BASED ON ITS TONIC NOTE, TEMPO IN BIT RATE, AND HARMONIC STRUCTURE . . . EACH MUSICAL ITEM GETS ASSIGNED ONE COLOUR, CREATING A NEW WAY TO CATEGORISE MUSICAL ITEMS.

COLOURS, WHEN USED ON VISUAL COMMUNICATION, ARE ASSOCIATED WITH SPECIFIC PROPERTIES. EACH COLOUR COMMUNICATES DISTINCT PROPERTIES UNIVERSALLY UNDERSTOOD BY HUMANS AND IDENTIFIED WITH DIFFERENT MOODS.

EXAMPLE GIVEN: RED IS ASSOCIATED WITH EXCITEMENT, BLUE IS ASSOCIATED WITH TRANQUILITY.

### BRIEF DESCRIPTION OF THE SEVERAL VIEWS OF THE DRAWING

FIG. 1A: INITIAL PAGE WHERE COLOURFUL BUTTONS¹ (ONE PER COLOUR) THAT ENABLE USERS TO ACCESS EVERY DIFFERENT SECTION OF THE CATALOGUE.

FIG. 2A: EXAMPLE OF CATALOGUE SECTIONS, A VIEW OF HOW MUSICAL ITEMS ARE DISPLAYED ON SCREEN, READY TO BE LISTENED TO (PLAY BUTTON²), DOWNLOADED (DOWNLOAD BUTTON³) AND OR FURTHERED EXPLORED ACCESSING THE ITEM'S DETAIL PAGES VIA A DIRECT HYPER-LINK ON THE ENTRY TITLE¹.

FIG. 3A: EXAMPLE OF A MUSICAL ITEM DETAIL PAGE AND HOW ALL INFORMATION RELATED TO THE PARTICULAR ITEM IS ACCESSIBLE TO USERS: ITEM'S TITLE¹, PLAY BUTTON², DETAIL INFORMATION³, AUTHOR INFORMATION AND ACCURACY FEATURE⁴, DOWNLOAD BUTTON⁵ AND VOTING FEATURE⁶.

### DETAILED DESCRIPTION OF THE INVENTION

“LEERECS SYNESTHETIC LIBRARY” IS A COMPUTER PROGRAMME TO CATALOGUE MUSIC BY COLOUR; BASED ON ITS TONIC NOTE, TEMPO IN BIT RATE, AND HARMONIC STRUCTURE . . . EACH MUSICAL ITEM GETS ASSIGNED ONE COLOUR, CREATING A NEW WAY TO CATEGORISE MUSICAL ITEMS.

“LEERECS SYNESTHETIC LIBRARY” WAS DESIGNED AND DEVELOPED BY THE FIRST NAMED INVENTOR JOSE ANTONIO LEMOS-MUNOZ; PROGRAMMED ON PHP, JAVASCRIPT, HTML AND CSS PROGRAMMING CODE, TO BE OPERATED ON THE INTERNET BROWSER OF COMPUTERS AND DIGITAL DEVICES SUCH AS SMART PHONES OR TABLETS. STORING AND ACCESSING DATA IN OUR MYSQL DATABASE.

COLOURS, WHEN USED ON VISUAL COMMUNICATION¹, ARE ASSOCIATED WITH SPECIFIC PROPERTIES. EACH COLOUR COMMUNICATES DISTINCT PROPERTIES UNIVERSALLY UNDERSTOOD BY HUMANS AND IDENTIFIED WITH DIFFERENT MOODS.

EXAMPLE GIVEN: RED IS ASSOCIATED WITH EXCITEMENT, BLUE IS ASSOCIATED WITH TRANQUILITY.

OLDER WAYS AND ALL OTHER CATALOGUES REQUIRE PREVIOUS KNOWLEDGE—IDIOMATIC, CULTURAL, OR SPECIFIC TO MUSIC, ETC.—TO BROWSE AND FIND THE MOOD OF MUSIC THE USER IS LOOKING FOR. IT CAN BE DIVISIVE, INACCURATE, UNINTUITIVE AND INEFFECTIVE.

EXAMPLE GIVEN: IF A USER IS LOOKING FOR RELAXING MUSIC, SHOULD THEY GO TO SMOOTH JAZZ, BLUES, POP SECTIONS AND THEN READ THE DESCRIPTIONS, IN CASE THEY ARE WRITTEN IN A LANGUAGE THEY UNDERSTAND, AND AMONG OTHER STEPS, LASTLY LISTEN TO THE PREVIEW TO—MAYBE—FIND MUSIC OF THEIR LIKING. AT THE VERY LEAST, AND ASSUMING THE USER HAS THE PARTICULAR KNOWLEDGE REQUIRED TO BROWSE MUSIC THIS WAY, THE TASK HAS BEEN TIME CONSUMING, EXTENSIVE AND INEFFECTIVE. NOT MENTIONING IT LEAVES OUT POSSIBLE MATCHES THAT WERE NOT DISCOVERED BY THE USER DUE TO FAULTY TAGGING OR PREDICAMENT (MAYBE A VERY GOOD MATCHING MUSICAL ITEM WAS CATALOGUED UNDER A MUSICAL GENRE UNFAMILIAR TO THE USER).

WITH THE “LEERECS SYNESTHETIC LIBRARY” MUSIC ITEMS ARE CATALOGUED BY MOOD UNDER SYMBOLISM UNIVERSALLY UNDERSTANDABLE: COLOURS. THIS CAN BE ANALOGOUS TO THE ICONS THAT INDICATE RESTAURANT, RESTROOM OR TELEPHONE AT AN AIRPORT. ELIMINATING ALL LINGUISTIC BARRIERS, PREDICAMENTS OR PREJUDGES, FAULTY TAGGING OR EXCLUSIVE CULTURAL KNOWLEDGE.

COMPONENT 1. MATCHING ALGORITHM STRUCTURE: THE “LEERECS SYNESTHETIC LIBRARY” COMPUTER PROGRAMME'S DATABASE STRUCTURE ENABLES CATEGORISING MUSIC ITEMS BY COLOUR BY MATCHING SEVERAL DIFFERENT INFORMATION TABLES VIA ONE VARIABLE: “ICON”.

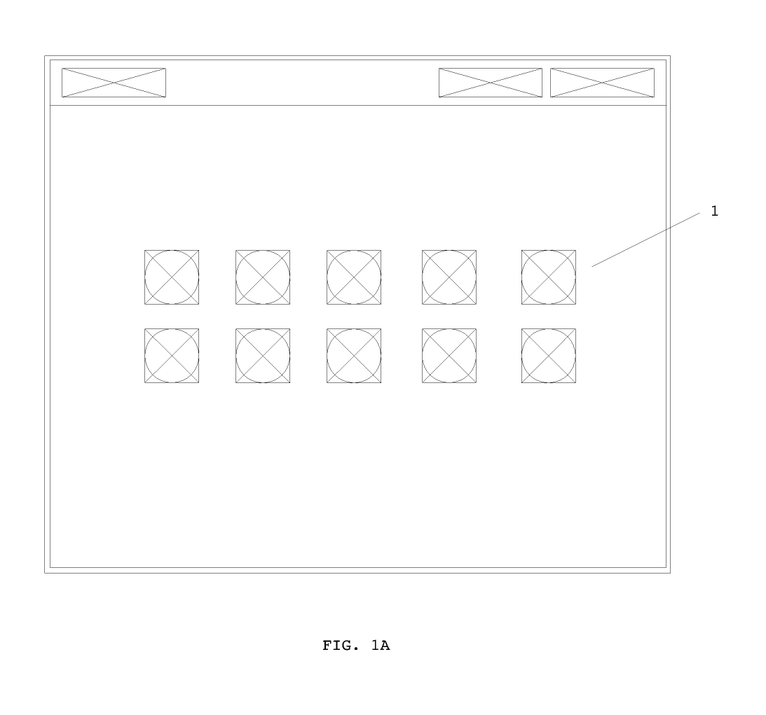

“ICON” IS PRESENT IN ALL RELATED TABLES AND CONNECTS ALL RELEVANT INFORMATION IN ONE PARTICULAR MUSICAL ITEMS—AUTHOR, DATE OF RELEASE, GENRE, NUMBER OF POSITIVE VOTES, MEDIA FILE, ETC. . . . —WITH ITS COLOUR ENTRY AND RELATED INFORMATION WHERE “ICON” IS THE SAME (FIG. 1).

THE DETAILS RELEVANT TO EACH COLOUR, AS WELL AS HOW THEY ASSOCIATE TO DIFFERENT MUSIC GENRES, ARE DEFINED WITHIN THE “COLOURS TABLE”, SEPARATED BY DISTINCT IDENTIFICATION NUMBERS.

*THE INFORMATION COMPRISING ONE SINGLE MUSICAL ITEM ENTRY IS SOURCED FROM SEVERAL TABLES WHERE SELECTIVE DATA IS DERIVED.

COMPONENT 2. VOTING FEATURE, SOFTWARE FUNCTIONALITY: ALL USERS OF THE “LEERECS SYNESTHETIC LIBRARY” COMPUTER PROGRAMME HAVE AN OPTION TO VALIDATE EACH COLOUR ASSIGNATION BY INDICATING IF THEY AGREE OR DISAGREE WITH THE COLOUR OF A PARTICULAR MUSICAL ITEM. THIS UNIQUE FEATURE PROVIDES OUR SOFTWARE WITH A SMARTER VALIDATION PROCESS BEYOND THE THEORY; THE LARGER POSITIVE VOTES RATIO OF AN ITEM, THE HIGHER ITS POSITIONS ON THE PUBLIC CATALOGUE WHEN BROWSING BY COLOUR.

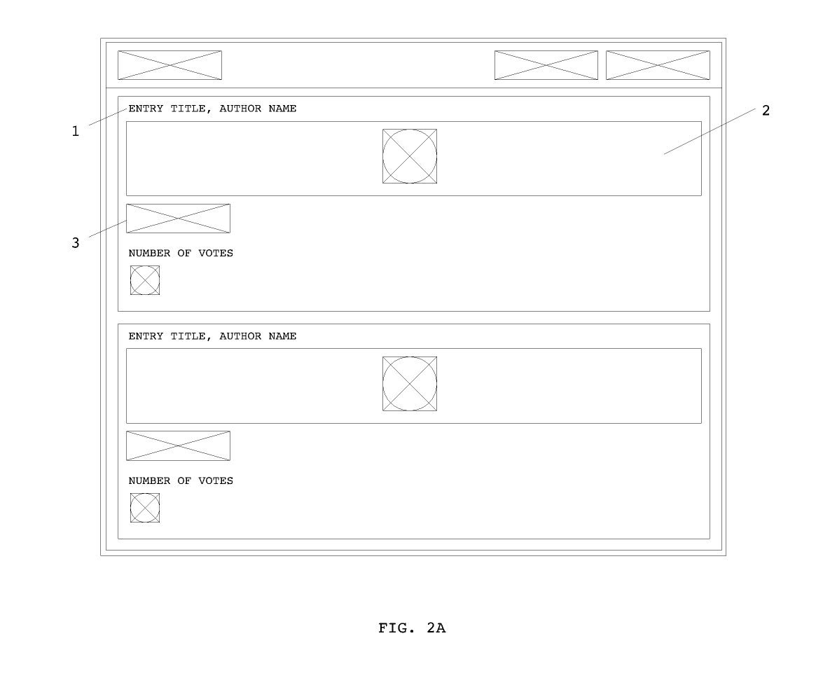

THIS IS AN EXCLUSIVE FEATURE—WITHIN THIS CONTEXT—THAT MAKES THE “LEERECS SYNESTHETIC LIBRARY” COMPUTER PROGRAMME ACCURATE (FIG. 2).

COMPONENT 3: KARMA³ FEATURE, SOFTWARE FUNCTIONALITY: TO ENSURE THE “LEERECS SYNESTHETIC LIBRARY” COPUTER PROGRAMME'S “VOTING FEATURE” ONLY CONSIDERS DATA POINTS PROVIDED IN GOOD FAITH, WE HAVE DEVELOPED OUR “KARMA FEATURE”: AN EXCLUSIVE FEATURE SOFTWARE FUNCTIONALITY—IN THIS CONTEXT—THAT ALLOWS OUR USERS EVALUATE THE GOOD BEHAVIOR OF THE COMMUNITY. THOSE USERS WHOSE CONTRIBUTIONS IN AGGREGATE ARE CONSIDERED ACCURATE CAN BE REWARDED WITH POSITIVE KARMA VOTES AND VICE-VERSA.

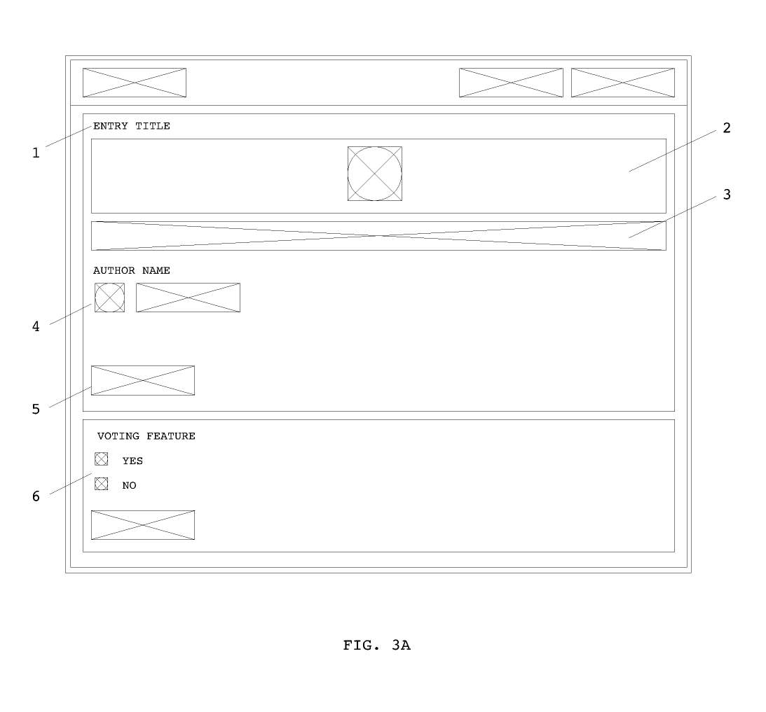

THE “LEERECS SYNESTHETIC LIBRARY” COMPUTER PROGRAMME “VOTING FEATURE” (COMPONENT 2) ONLY COUNTS THE VOTES OF THOSE USERS WITH A POSITIVE VOTE RATIO IN THEIR “KARMA FEATURE” (FIG. 3).

COMPONENT 4. COLOUR AND MUSICAL NOTE CORRESPONDENCE ALGORITHM: THE “LEERECS SYNESTHETIC LIBRARY” COMPUTER PROGRAMME ALGORITHM IS PROGRAMMED TO MATCH MUSICAL ITEM'S TONIC NOTES WITH THEIR CORRESPONDING COLOURS ACCORDING TO THE CHAKRAS THEORY² BY DEFAULT.

THE “LEERECS SYNESTHETIC LIBRARY” COMPUTER PROGRAMME CAN ALSO BE EXPANDED WITH MULTIPLE DIFFERENT MATCHING ALGORITHMS BASED ON EVERY DIFFERENT PARTICULAR AUDIENCE AND MUSICAL GENRE, INFORMED WITH OUR PROPRIETARY DATA POINTS FROM OUR VOTING FEATURE, MAKING THE “LEERECS SYNESTHETIC LIBRARY” COMPUTER PROGRAMME FLEXIBLE AND SCALABLE.

COMPONENT 5. PROPRIETARY MATCHING ALGORITHM FOR ROCK MUSIC GENRE: THE “LEERECS SYNESTHETIC LIBRARY” COMPUTER PROGRAMME DATA POINTS FROM AN AUDIENCE OF THE ROCK MUSICAL GENRE HELPED US DEFINE OUR SPECIFIC PROPRIETARY CORRESPONDENCE OF MUSICAL NOTES TO COLOURS FOR THE ROCK GENRE ONLY, AS ILLUSTRATED ON THE GRAPHIC BELOW (FIG. 4):

Definitions: 1. Visual communication: communication through a visual aid and is described as the conveyance of ideas and information in forms that can be read or looked upon. 2. Chakras: (in Indian thought) each of the centres of spiritual power in the human body, usually considered to be seven in number. 3. Karma: (in Hinduism and Buddhism) the sum of a person's actions in this and previous states of existence, viewed as deciding their fate in future existences.

1. A COMPUTER PROGRAM TO CATALOG SONGS BY COLOR IN A COMMERCIAL INVENTORY, WHERE EACH SONG GETS ASSIGNED ONE COLOR (AS DESCRIBED ON CLAIMS 6 AND 7)—RATHER THAN A MUSICAL GENRE—TO BE CATEGORIZED UPON, COMPRISING VOTING FEATURES WHERE THE USERS CAN VALIDATE BOTH THE COLOR/SONG JUNCTIONS AND THE ACCURACY OF OTHER USERS' VOTES.

2. A “VOTING FEATURE” WHERE THE USERS OF OUR COMPUTER PROGRAM—FROM CLAIM 1—CAN VALIDATE THE COLOR ASSIGNATIONS TO THE SONGS IN THE CATALOG BY INDICATING IF THEY AGREE OR DISAGREE WITH THE COLOR OF A PARTICULAR SONG BY VOTING EITHER POSITIVELY OR NEGATIVELY ONLY ONCE.

3. AN “ACCURACY FEATURE” WHERE THE USERS OF OUR COMPUTER PROGRAM—FROM CLAIM 1—CAN EVALUATE OTHER USERS' VOTING ACCURACY—FROM CLAIM 2—BY REWARDING WITH POSITIVE POINTS THOSE USERS WHOSE CONTRIBUTIONS ARE CONSIDERED ACCURATE, AND WITH NEGATIVE POINTS IF THEY ARE INACCURATE.

4. A “DIRECTORY FEATURE” WHERE THOSE SONGS WITH A LARGER POSITIVE VOTES RATIO FROM THE VOTING FEATURE—FROM CLAIM 2—POSITION HIGHER ON THE PUBLIC CATALOG LISTING WHEN USERS BROWSE BY COLOR, WHEREAS THOSE SONGS WITH SMALLER POSITIVE VOTES RATIO POSITION LOWER ON THE LISTING.

5. A “CONTRAST FEATURE” WHERE OUR COMPUTER PROGRAM “VOTING FEATURE”—FROM CLAIM 2—ONLY COUNTS THE VOTES OF THOSE USERS WITH A POSITIVE POINTS RATIO IN THEIR “ACCURACY FEATURE”—FROM CLAIM 3—.

6. A “DEFAULT ALGORITHM” WHERE OUR COMPUTER PROGRAM MATCHES SONGS WITH COLORS BASED ON THEIR TONIC NOTE ACCORDING TO THE CHAKRAS THEORY: A—INDIGO; B—VIOLET; C—RED; D—ORANGE; E—YELLOW; F—GREEN; G—BLUE.

7. A “ROCK GENRE ALGORITHM” WHERE THE MATCHING SEQUENCE—BETWEEN COLORS AND MUSICAL NOTES—HAS BEEN DETERMINED TO BE MOST ACCURATE FOR THE ROCK MUSIC GENRE BASED ON OUR DATA FROM THE VOTES IN OUR “VOTING FEATURE” (CLAIM NUMBER 3): ORANGE—A; YELLOW—B; RED—C; LIGHT ORANGE—D; BLUE—E; INDIGO—F; VIOLET—F#; GREEN—G.
